(19) United States
(12) Patent Application Publication
(10) Pub. No.: US 2008/0247107 A1
(43) Pub. Date: Oct. 9, 2008

(54) APPARATUS AND METHOD FOR MONITORING, DETECTING AND RECOVERING FROM AN OVERCURRENT CONDITION

(75) Inventors: Jeng-Hua Lin, Columbus, OH (US); Art Towslee, Westerville, OH (US); Russell Vires, Powell, OH (US)

Correspondence Address: STANDLEY LAW GROUP LLP, 495 METRO PLACE SOUTH, SUITE 210, DUBLIN, OH, 43017, US

(73) Assignee: Mettler-Toledo, Inc., Columbus, OH (US)

(21) Appl. No.: 11/696,899

(22) Filed: Apr. 5, 2007

(51) Int. Cl. H02H 3/08; H02H 3/093

(52) U.S. Cl. 361/59; 361/93.1; 361/93.2

(57) ABSTRACT

A weighing apparatus having a circuit for monitoring, detecting and recovering from an overcurrent condition is described. The circuit may include a switch, current sensor, latch circuitry and microprocessor. The microprocessor may allow the circuit to recover from the overcurrent condition.

### BACKGROUND AND SUMMARY OF THE EXEMPLARY EMBODIMENTS

The exemplary embodiments relate generally to weighing apparatus and more specifically to a circuit in a weighing apparatus component that allows for monitoring, detecting and recovering from an overcurrent condition.

Weighing apparatus generally include a load-receiving surface, one or more force-measuring devices and an indicator or terminal. Any number of these components may be standalone or be incorporated together in a single unit. The indicator may include a plurality of circuit boards. The circuit boards may allow the indicator to perform a number of functions. One such board may be an analog load cell interface board. This board may supply power to one or more analog load cells.

The analog load cell interface board may need to be protected from a short circuit in the wiring that may be connected to one or more analog load cells. This may be so that an overcurrent condition does not expose the indicator to the overload and potentially damage the indicator. Typically, this has been accomplished through the use of a positive temperature co-efficient resistor (PTC). The PTC changes resistance in response to its temperature. If an overload occurs, the temperature of the PTC rises. As the temperature increases, the PTC's resistance increases to a point where the PTC will no longer allow current to flow through it. As the temperature decreases, the PTC's resistance will decrease and eventually current will flow through it once again. It may take a long time for the PTC's resistance to rise or fall to the level of preventing or allowing current flow.

FIG. 1 illustrates a prior art circuit 100 using a PTC 104. The power source 102 may be connected to a PTC 104. Current may flow from the power source to the PTC 104. The PTC 104 may be connected to a regulator 106 which may regulate or stabilize the voltage that flows to the load cells 108. If an overcurrent occurs in the circuit 100, the temperature of the PTC 104 begins to increase, which increases its resistance, eventually causing current flow to cease. While this arrangement works well for non-hazardous environments, due to the PTC's slow reaction time, they may not be suitable for use in some hazardous environments, which require quick responses to avoid dangerous situations. The exemplary embodiments can be used in both non-hazardous and hazardous environments, thus allowing one board for all conditions. This may be advantageous for manufacturing and service purposes.

The exemplary embodiments attempt to solve or mitigate these problems. The exemplary embodiments may be directed to a weighing apparatus which may have a plurality of load cells, a load receiving surface associated with said plurality of load cells and an indicator having a circuit. The circuit may be responsible for providing power to the load cells through a power source. A switch having an on position and an off position may be associated with the power source. A current sensor may sense the current in the circuit. Latch circuitry may be associated with the current sensor for turning the switch to the off position if the current sensor detects an overcurrent condition. A microprocessor may be associated with the latch circuitry for recovering the circuit from the overcurrent condition.

### BRIEF DESCRIPTION OF THE DRAWINGS

In addition to the features mentioned above, other aspects of the exemplary embodiments will be readily apparent from the following descriptions of the drawings, wherein like reference numerals across the several views refer to identical or equivalent features, and wherein:

FIG. 1 illustrates a schematic of a prior art circuit.

FIG. 2 illustrates an exemplary embodiment of a weighing apparatus.

FIG. 3 illustrates a schematic of one exemplary embodiment of a circuit.

FIG. 4 illustrates a schematic of another exemplary embodiment of a circuit.

FIG. 5 illustrates a detailed schematic of one exemplary embodiment of a circuit.

FIG. 6 illustrates an operation diagram of one exemplary embodiment of a circuit showing different aspects of the circuit during operation from startup through an overcurrent condition and back to steady state.

FIG. 7 illustrates a flow chart of one exemplary embodiment.

FIG. 8 illustrates a flow chart of another exemplary embodiment.

FIG. 9 illustrates a flow chart of another exemplary embodiment.

### DETAILED DESCRIPTION OF THE EXEMPLARY EMBODIMENT(S)

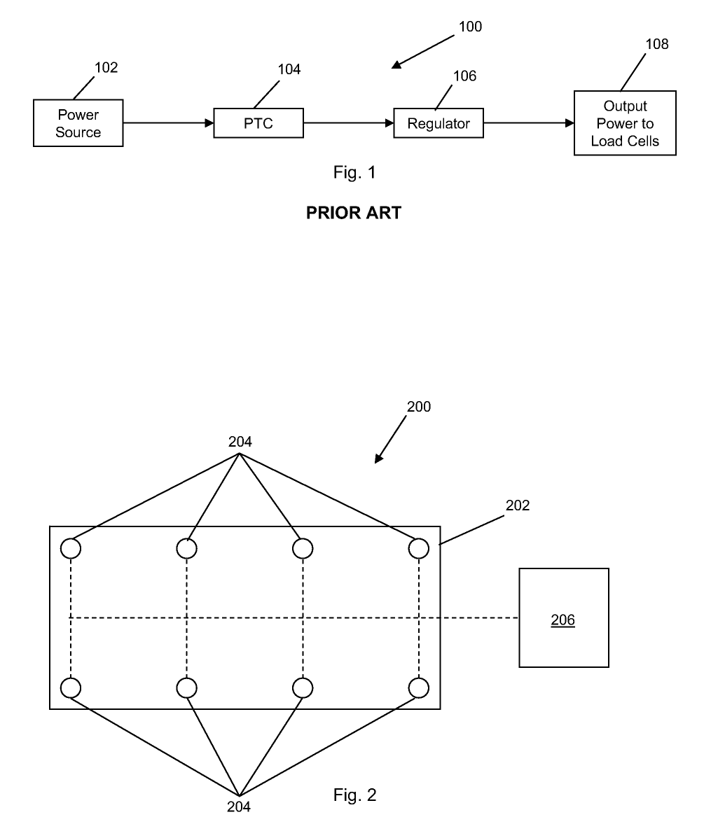

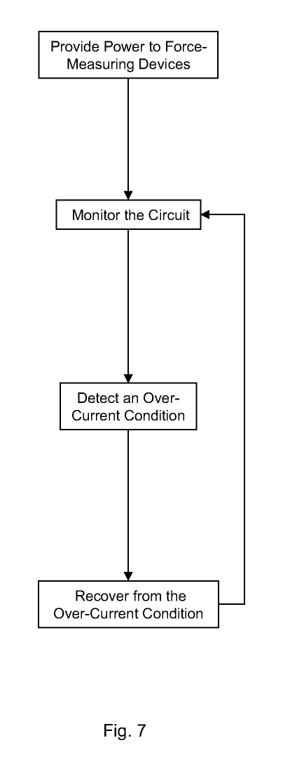

In a broad sense and as shown in FIG. 7, the exemplary embodiments may detect an overcurrent condition in a circuit, monitor the overcurrent condition and assist the circuit in recovering from the overcurrent condition. This may help to prevent damage to the circuit or other components connected to the circuit. FIG. 2 illustrates one exemplary embodiment of a weighing apparatus 200. The weighing apparatus 200 may be any weighing apparatus known in the art, such as but not limited to, truck scales, rail scales, floor scales, tank scales, hopper scales, palette scales, fork truck scales, in-motion scales, retail scales, lab balances and any other similar weighing apparatus. Generally, the weighing apparatus 200 may include a load receiving surface 202. The load receiving surface 202 may be any size and shape as may be known in the art. A plurality of force-measuring devices 204 may be associated with the load receiving surface 202 in any manner known in the art. The force-measuring devices 204 may be any device that can convert a force into an electrical signal, such as but not limited to, analog load cells. The weighing apparatus 200 may include an indicator or terminal 206. The indicator 206 may have any configuration known in the art. For example, the indicator 206 can be a non-programmable indicator, a programmable indicator or a personal computer. The indicator 206 may include one or more printed circuit boards (PCB).

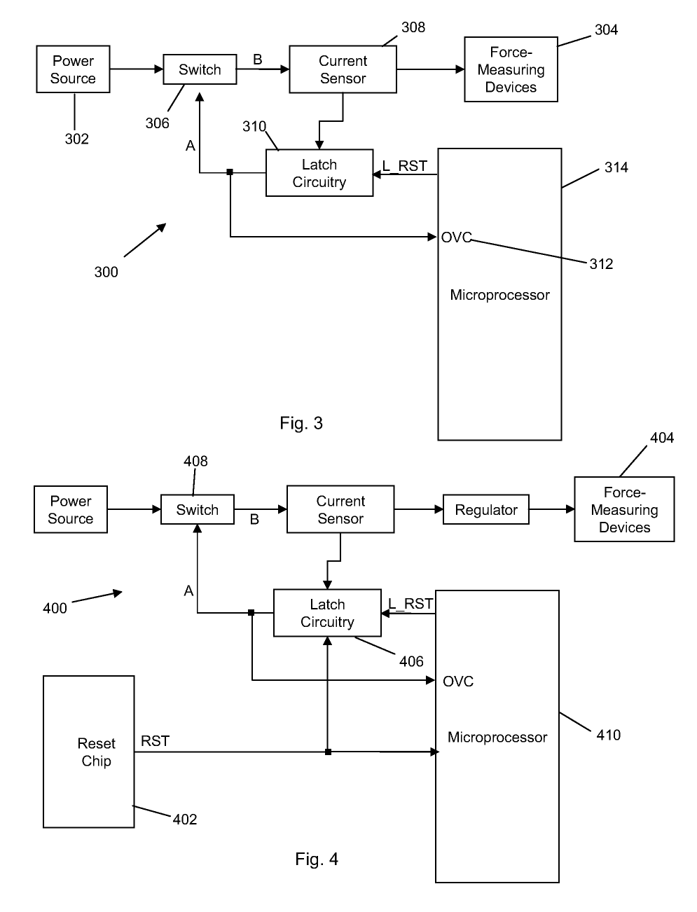

FIG. 3 illustrates a schematic of one exemplary circuit 300. Operation of the circuit 300 will also be described, with reference to FIG. 9. The circuit 300 includes a power source 302 which may provide power to a plurality of force-measuring devices 304. The power source 302 may be any power source known in the art. In one exemplary embodiment, the power source 302 may be a 12-volt power source. A switch 306 may be connected between the power source 302 and force-measuring devices 304. The switch 306 may be used to stop the flow of current should an overcurrent condition be detected. A current sensor 308 may be connected between the switch 306 and force-measuring devices 304. The current sensor 308 may sense the current passing between the power source 302 and force-measuring devices 304. The circuit 300 may also include latch circuitry 310. The latch circuitry 310 may be enabled or disabled. When enabled, the latch circuitry 310 may maintain its output once the current sensor 308 detects an overcurrent condition. When disabled, the latch circuitry 310 may allow its output to change based on its inputs.

During steady state mode, shown in the top part of FIG. 9, the switch 306 may be in the on position and latch circuitry 310 may be enabled. This may allow current to flow through the rest of circuit 300 and to the force-measuring devices 304 normally. The current sensor 308 may continuously monitor the circuit for an overcurrent condition. When an overcurrent condition occurs, the current sensor 308 may sense that the current is above a predetermined threshold. The overcurrent flag 312 may be set in the microprocessor 314 and timers M1 and M2 may be reset. The latch circuitry 310 may be disabled and the switch 306 may be set to the off position. This may cut power to the force-measuring devices 304. The order in which these steps occur is not important. For example, the switch may be turned off before the overcurrent flag is set or the latch circuitry 310 may be disabled after the switch 306 is turned off.

Next, the microprocessor 314 may determine whether or not M1 has timed out. If M1 has not timed out, the current sensor 308 may sense that the current is below the predetermined threshold and the latch circuitry 310 may turn the switch 306 on. If the overcurrent condition is still present, then the current sensor 308 may sense that the current is above the predetermined threshold and the latch circuitry 310 may set the switch 306 to the off position. This may cause the current sensor 308 to sense that the current is below the predetermined threshold once again causing the switch 306 to be set to the on position. This process may repeat as long as the overcurrent condition is still present and before M1 times out. This may cause the switch to toggle between the on and off positions rapidly.

If, during M1, the overcurrent condition is removed, then the current sensor 308 may sense that the current level is below the predetermined threshold and the switch 306 may remain in the on position. Once M1 expires, the microprocessor 314 may clear the overcurrent flag 312 and enable the latch circuitry 310. If at that time, the current is below the predetermined threshold then the circuit 300 may return to steady state mode and operate normally. However, if at that time, the current is above the predetermined threshold then the microprocessor 314 may wait a predetermined period of time, such as timer M2, and repeat the above process until the overcurrent condition is removed.

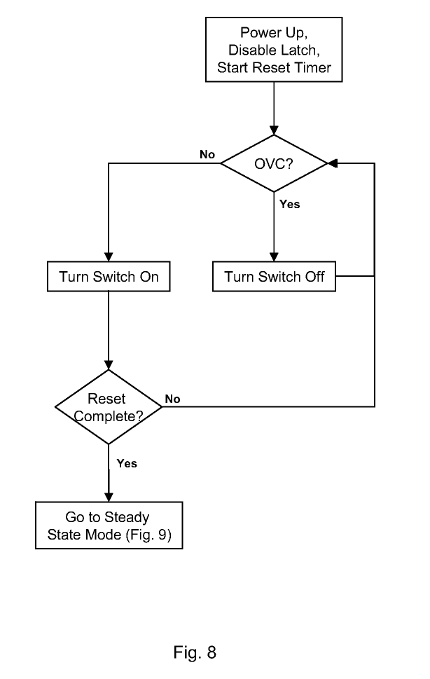

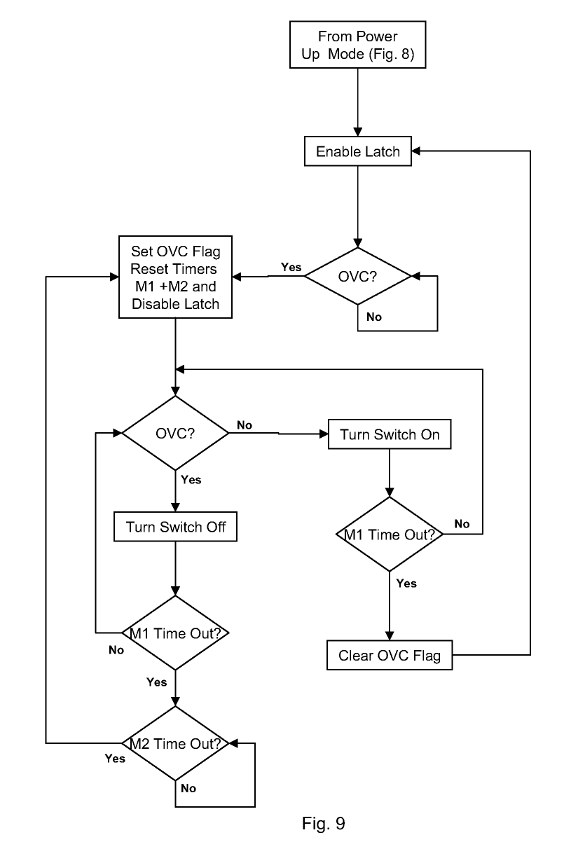

Another exemplary embodiment of a circuit 400 is illustrated in FIG. 4 and with reference to FIGS. 7-9. This exemplary embodiment is similar to the exemplary embodiment illustrated in FIG. 3 with the addition of a reset chip 402 and associated circuitry. During power up mode, the reset chip 402 may handle the power sequence. This may be needed if there is a large in-rush current to energy storage devices associated with the circuit 400. For example, such devices may be in the indicator, on the board, in the electrical lines or in the load cell. Examples of energy storage devices include but are not limited to, batteries, capacitors, inductors or any other similar devices. The reset chip 402 may disable the latch circuitry 406 which may allow the switch 408 to turn on and off based on the sensed current. The reset chip 402 may maintain this state until the power up sequence may be completed. The reset chip 402 may also keep the microprocessor 410 in a reset state until the power is stabilized. After a predetermined amount of time, the reset chip 402 will enable the latch circuitry 406 for steady state mode.

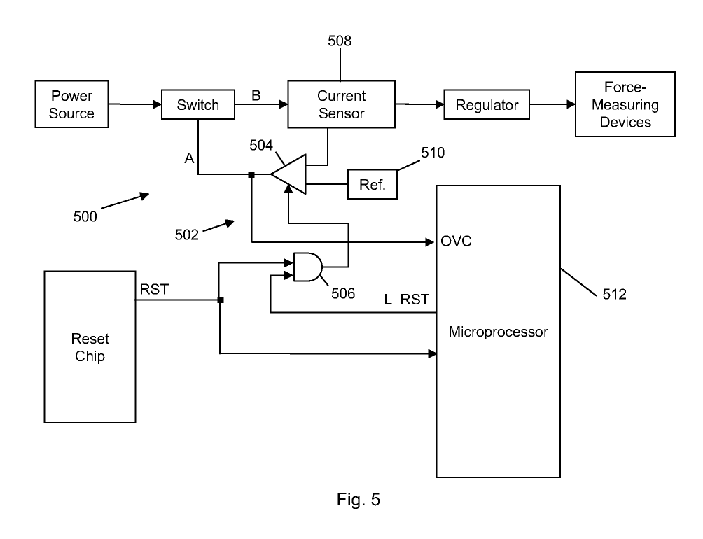

FIG. 5 illustrates another exemplary embodiment of a circuit 500. This figure illustrates a circuit 500 similar to FIGS. 3 and 4. The latch circuitry 502 is shown in more detail. The latch circuitry 502 may include a comparator 504 and an AND gate 506. The comparator 504 may compare the current sensed by the current sensor 508 and compare it to a reference value 510 to determine whether or not an overcurrent condition is present. The AND gate 506 may enable and disable the latching of the comparator 504 output, similar to the latch circuitry described above. The AND gate 506 would not be used in a circuit similar to that shown in FIG. 3 and the output from the microprocessor 512 would go directly to the comparator 504.

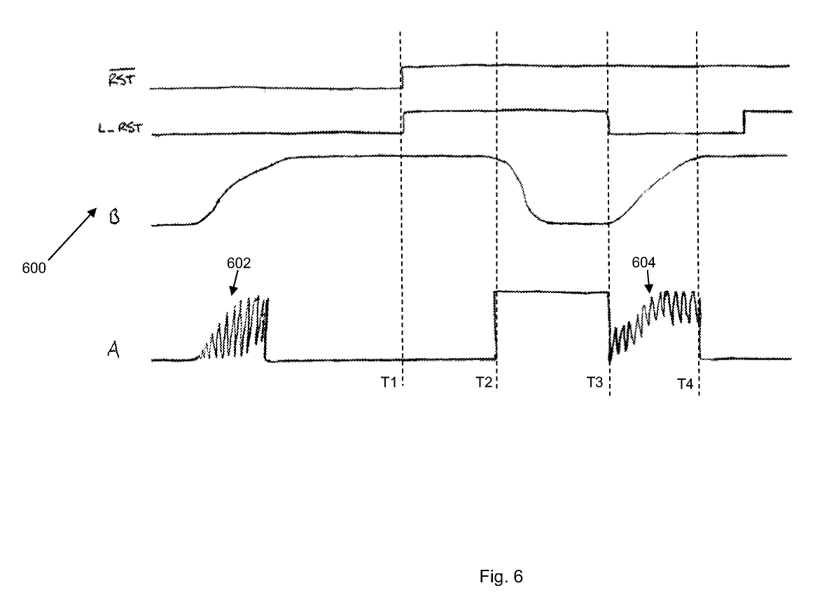

FIG. 6 illustrates the operation of the circuit from startup to steady state mode through an overcurrent condition and back to steady state mode. Each of the labels 600 on the left correspond to a location on the circuit 300, 400 or 500. As stated above, during startup an inrush current may occur as energy storage devices are filled. During this time, the power may be turned on and off rapidly, thus causing the sharp spikes shown at 602. The RST and L_RST lines may be held low for a predetermined period of time, determined by the reset chip 402 to allow the comparator output to update freely and to allow the power to stabilize. At time T1, after the predetermined period of time, the RST and L_RST lines may change to high which may allow the circuit to begin steady state mode. At time T2, an overcurrent condition occurs. Since the latch circuitry may be enabled at steady state, the output at A shows high and may remain high for a predetermined period of time, until the latch circuitry may be disabled. After that predetermined period of time, shown at time T3, the latch circuitry may be disabled. This may allow the switch to be turned on and off rapidly, once again causing the sharp spikes shown at 604. At time T4, the overcurrent condition is removed and the circuit may return to steady state mode.

While certain exemplary embodiments are described in detail above, the scope of the invention is not to be considered limited by such disclosure, and modifications are possible without departing from the spirit of the invention as evidenced by the following claims:

What is claimed is:

1. A weighing apparatus, comprising:
a plurality of load cells;
a load receiving surface associated with said plurality of load cells;
an indicator having a circuit, said circuit comprising:
a power source providing power to said load cells;
a switch associated with said power source, said switch having an on position and an off position;
a current sensor associated with said power source for sensing the current in the circuit;
latch circuitry associated with said current sensor, for turning said switch to said off position if said current sensor detects an overcurrent condition; and
a microprocessor associated with said latch circuitry for recovering said circuit from said overcurrent condition.

2. The weighing apparatus of claim 1 wherein said circuit further comprises:
an overcurrent flag associated with said microprocessor for indicating when an overcurrent condition is occurring.

3. The weighing apparatus of claim 2 wherein said circuit further comprises:
a regulator associated with said power source for regulating the power to said force-measuring devices.

4. The weighing apparatus of claim 3 wherein said circuit further comprises:
a reset chip associated with said microprocessor and latch circuitry.

5. The weighing apparatus of claim 2 wherein said circuit further comprises:
a reset chip associated with said microprocessor and latch circuitry.

6. The weighing apparatus of claim 1 wherein said circuit further comprises:
a regulator associated with said power source for regulating the power to said force-measuring devices.

7. The weighing apparatus of claim 1 wherein said circuit further comprises:
a reset chip associated with said microprocessor and latch circuitry.

8. The weighing apparatus of claim 7 wherein said circuit further comprises:
an AND gate associated with said reset chip and said microprocessor.

9. The weighing apparatus of claim 1 wherein said latch circuitry comprises:
a comparator connected to said current sensor; and
a reference value connected to said comparator.

10. The weighing apparatus of claim 1 wherein said circuit further comprises:
a regulator associated with said power source for regulating the power to said force-measuring devices;
an overcurrent flag associated with said microprocessor for indicating when an overcurrent condition is occurring;
a reset chip associated with said microprocessor and latch circuitry;
an AND gate associated with said reset chip and said microprocessor;
a comparator connected to said current sensor; and
a reference value connected to said comparator.

11. A method for protecting a circuit from an overcurrent condition, said circuit having a switch, a reference value, an overcurrent flag and latch circuitry, comprising:
providing power to a plurality of force-measuring devices;
monitoring said circuit;
detecting an overcurrent condition; and
recovering from said overcurrent condition.

12. The method of claim 11 wherein said monitoring step comprises:
(a) comparing a sensed current to said reference value.

13. The method of claim 12 wherein said monitoring step further comprises:
(b) setting said overcurrent flag;
(c) resetting a timer M1 and a timer M2; and
(d) disabling said latch circuitry.

14. The method of claim 13 wherein said detecting step comprises:
(e) setting said switch to an off position
(f) determining whether said timer M2 has timed out; and
(g) comparing a sensed current to said reference value.

15. The method of claim 14 wherein said detecting step further comprises:
(h) setting said switch to an on position;
(i) determining whether said timer M2 has timed out;
(j) comparing a sensed current to said reference value; and
(k) repeating steps (e)-(j) until said timer M1 times out.

16. The method of claim 15 wherein said recovering step comprises:
(m) repeating steps (b)-(l) until said overcurrent condition is removed.

17. The method of claim 16 wherein said recovering step comprises:
(n) clearing said overcurrent flag; and
(o) enabling said latch circuitry.

18. The method of claim 11 wherein said powering step comprises:
(a) disabling said latch circuitry;
(b) comparing a sensed current to said reference value;
(c) setting said switch to an on position;

19. The method of claim 18 wherein said powering step further comprises:
(d) comparing a sensed current to said reference value;
(e) setting said switch to an off position; and
(f) repeating steps (b)-(e) for a predetermined period of time.

20. A method for protecting a circuit from an overcurrent condition, said circuit having a switch, a reference value, an overcurrent flag and latch circuitry, comprising:
(a) comparing a sensed current to said reference value;
(b) setting said overcurrent flag;
(c) resetting a timer M1 and a timer M2;
(d) disabling said latch circuitry;
(e) setting said switch to an off position
(f) determining whether said timer M2 has timed out;
(g) comparing a sensed current to said reference value;
(h) setting said switch to an on position;
(i) determining whether said timer M2 has timed out;
(j) comparing a sensed current to said reference value;
(k) repeating steps (e)-(j) until said timer M1 times out;
(l) waiting for timer T2 to time out;
(m) repeating steps (b)-(l) until said overcurrent condition is removed;
(n) clearing said overcurrent flag; and
(o) enabling said latch circuitry.
